(19) United States
(12) Patent Application Publication
(10) Pub. No.: US 2012/0138528 A1
(43) Pub. Date: Jun. 7, 2012

(54) METHOD AND APPARATUS FOR REMOVING ARSENIC FROM AN ARSENIC BEARING MATERIAL

(75) Inventors: John L. Burba, III, Parker, CO (US); Carl R. Hassler, Gig Harbor, WA (US); C. Brock O'Kelley, Las Vegas, NV (US); Charles F. Whitehead, Las Vegas, NV (US)

(73) Assignee: MOLYCORP MINERALS, LLC, Greenwood Village, CO (US)

(21) Appl. No.: 11/958,602

(22) Filed: Dec. 18, 2007

Related U.S. Application Data
(60) Provisional application No. 60/882,365, filed on Dec. 28, 2006.

(51) Int. Cl. C02F 1/62; B01D 15/26; B01D 39/06; B01D 11/02; B01D 36/00; C25C 1/00; C01G 1/00

(52) U.S. Cl. 210/638; 210/259; 210/251; 210/195.1; 210/253; 423/1; 205/771

(57) ABSTRACT

A method and apparatus for removing arsenic from an arsenic-bearing material. The method includes the steps of contracting an arsenic-bearing material with an arsenic leaching agent to form an arsenic-containing solution and arsenic-depleted solids. The leaching agent can be an inorganic salt, an inorganic acid, an organic acid, and/or an alkaline agent. The arsenic-depleted solids are separated from the arsenic-containing solution, which is contacted with a fixing agent to produce an arsenic-depleted solution and an arsenic-laden fixing agent. The fixing agent comprises a rare earth-containing compound that can include cerium, lanthanum, or praseodymium. The fixing agent is then separated from the arsenic-depleted solution. A recoverable metal in the arsenic-depleted solids, arsenic-containing solution or arsenic-depleted solution can be separated and recovered. Recoverable metals can include metal from Group IA, Group IIA, Group VIII and the transition metals.

### FIELD OF THE INVENTION

This invention relates generally to the removal of arsenic from arsenic bearing materials, and specifically, to the fixing of arsenic from solutions formed from such materials.

### BACKGROUND OF THE INVENTION

The presence of arsenic in waters, soils and waste materials may originate from or have been concentrated through geochemical reactions, mining and smelting operations, the land-filling of industrial wastes, the disposal of chemical agents, as well as the past manufacture and use of arsenic-containing pesticides. Because the presence of high levels of arsenic may have carcinogenic and other deleterious effects on living organisms and because humans are primarily exposed to arsenic through drinking water, the U.S. Environmental Protection Agency (EPA) and the World Health Organization have set the maximum contaminant level (MCL) for arsenic in drinking water at 10 parts per billion (ppb). As a result, a problem facing industries such as mining, metal refining, steel manufacturing, glass manufacturing, chemical and petro-chemical and power generation is the reduction or removal of arsenic from process streams, effluents and byproducts.

Arsenic occurs in the inorganic form in aquatic environments primarily the result of dissolution of solid phase arsenic such as arsenolite (As₂O₃), arsenic anhydride As₂O₅) and realgar (AsS₂). Arsenic occurs in water in four oxidation or valence states, i.e., −3, 0, +3, and +5. Under normal conditions arsenic is found dissolved in aqueous or aquatic systems in the +3 and +5 oxidation states, usually in the form of arsenite (AsO₂⁻¹) and arsenate (AsO₄⁻³). The effective removal of arsenic by coagulation techniques requires the arsenic to be in the arsenate form. Arsenite, in which the arsenic exists in the +3 oxidation state, is only partially removed by adsorption and coagulation techniques because its main form, arsenious acid (HAsO₂), is a weak acid and remains un-ionized at pH levels between 5 and 8 when adsorption is most effective.

Various technologies have been used to remove arsenic from aqueous systems. Examples of such techniques include adsorption on high surface area materials, such as alumina, activated carbon, lanthanum oxide and cerium dioxide, ion exchange with anion exchange resins, precipitation and electrodialysis. In the case of solid or semi-solid materials, attempts have been made to solidify or stabilize the arsenic in situ to prevent migration into surrounding soils or groundwater. However, because such stabilization procedures tend to be quite costly, and in some cases are unproven, there is a need for alternate methods and techniques for handing arsenic in such materials.

### SUMMARY OF THE INVENTION

In one embodiment, the present invention provides a method for removing arsenic from an arsenic-bearing material. The method includes the steps of contracting an arsenic-bearing material with an arsenic leaching agent to form an arsenic-containing solution and arsenic-depleted solids, and separating the arsenic-depleted solids from the arsenic-containing solution. The arsenic leaching agent can include one or more of an inorganic salt, an inorganic acid, an organic acid, and an alkaline agent.

The method further includes the step of contacting the arsenic-containing solution with a fixing agent under conditions in which at least a portion of the arsenic is fixed by the fixing agent to yield an arsenic-depleted solution and an arsenic-laden fixing agent and separating the arsenic-depleted solution from the arsenic-laden fixing agent. The fixing agent comprises a rare earth-containing compound. The rare earth-containing compound can include one or more of cerium, lanthanum, or praseodymium. Where the rare earth-containing compound comprises a cerium-containing compound, the cerium-containing compound can be derived from thermal decomposition of a cerium carbonate. The rare earth-containing compound can include cerium dioxide. When a recoverable metal is in solution in the arsenic-containing solution and the fixing agent comprises an insoluble compound that does not react with the recoverable metal to form an insoluble product.

The arsenic-containing solution can be contacted with the fixing agent by flowing the arsenic-containing solution through a bed of the fixing agent or by adding the fixing agent to the arsenic-containing solution. The arsenic-containing solution can have a pH of more than about 7, or more than about 9, or more than about 10, when the arsenic-containing solution is contacted with the fixing agent. In other embodiments, the arsenic-containing solution can have a pH of less than about 7, or less than about 4, or less than about 3, when the arsenic-containing solution is contacted with the fixing agent. The arsenic-containing solution can include at least about 1000 ppm sulfate when the arsenic-containing solution is contacted with the fixing agent.

One or more of the arsenic-containing solution, the arsenic-depleted solids, and the arsenic-depleted solution can include a recoverable metal. When present in the arsenic depleted solids, the method can optionally include the step of adding the arsenic-depleted solids to a feedstock in a metal refining process to separate the recoverable metal from the arsenic-depleted solids. When the recoverable metal is present in the arsenic-containing solution, the method can optionally include the step of electrolyzing or precipitating the recoverable metal from the arsenic-containing solution. When the recoverable metal is present in the arsenic-depleted solution, the method can optionally include the step of electrolyzing the arsenic-depleted solution to separate the recoverable metal from the arsenic-depleted solution. The recoverable metal can include a metal from Group IA, Group IIA, Group VIII and the transition metals.

In another embodiment, the present invention provides as apparatus for removing arsenic from an arsenic-bearing material. The apparatus includes a leaching unit for contacting the arsenic-bearing material with an arsenic leaching agent under conditions such that at least a portion of the arsenic is extracted to form an arsenic-containing solution and arsenic-depleted solids. A separator is provided for separating the arsenic-containing solution from the arsenic-depleted solids.

The apparatus further includes an arsenic fixing unit operably connected to the leaching unit to receive the arsenic-containing solution. The arsenic fixing unit includes a contact zone having a fixing agent comprising a rare earth-containing compound for contacting the arsenic-containing solution and fixing at least a portion of the arsenic to yield an arsenic-depleted solution and an arsenic-laden fixing agent. The contact zone of the arsenic fixing unit can be disposed in a tank, pipe, column or other suitable vessel. A separator is provided for separating the arsenic-laden fixing agent from the arsenic-depleted solution.

The fixing agent comprises a rare earth-containing compound. The rare earth-containing compound can include one or more of cerium, lanthanum, or praseodymium. Where the rare earth-containing compound comprises a cerium-containing compound, the cerium-containing compound can be derived from thermal decomposition of a cerium carbonate. The rare earth-containing compound can include cerium dioxide. When a recoverable metal is in solution in the arsenic-containing solution and the fixing agent comprises an insoluble compound that does not react with the recoverable metal to form an insoluble product.

The apparatus can optionally include a filtration unit connected to the arsenic fixing unit for receiving the arsenic-laden fixing agent and producing a filtrate. The filtration unit can optionally be in fluid communication with an inlet of the arsenic fixing unit for recycling the filtrate to the arsenic fixing unit.

The apparatus can optionally further include a second arsenic fixing unit that comprises a contact zone having a fixing agent comprising a rare earth-containing compound for contacting the arsenic-containing solution and fixing at least a portion of the arsenic to yield an arsenic-depleted solution. When the apparatus includes a second fixing unit, the apparatus can include a manifold in fluid communication with an inlet of each of the arsenic fixing units for selectively controlling a flow of the arsenic-containing solution to each of the arsenic fixing units, for selectively controlling a flow of a sluce stream to each of the arsenic fixing units and/or for selectively controlling a flow of fixing agent to each of the arsenic fixing units.

The apparatus can optionally further include a metal recovery unit operably connected at least one of the leaching unit and the arsenic fixing unit for separating a recoverable metal from one or more of the arsenic-depleted solids, the arsenic-containing solution, and the arsenic-depleted solution. The metal recovery unit can include one or more of an electrolyzer and a precipitation unit.

### BRIEF DESCRIPTION OF THE DRAWINGS

The invention may be understood by reference to the following description taken in conjunction with the accompanying drawings.

FIG. 1 is a flow chart representation of a method of the present invention.

FIG. 2A is a schematic view of an apparatus of the present invention.

FIG. 2B is a schematic view of an apparatus of the present invention.

FIG. 3A is a schematic view of an apparatus of the present invention.

FIG. 3B is a schematic view of an apparatus of the present invention.

FIG. 3C is a schematic view of an apparatus of the present invention.

FIG. 4 is a schematic view of an apparatus of the present invention.

FIG. 5 is a schematic view of an arsenic fixing unit suitable for use in an apparatus of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE PREFERRED EMBODIMENTS

Illustrative embodiments of the invention are described below. In the interest of clarity, not all features of an actual embodiment are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover it will be appreciated that such a development effort might be complex and time-consuming, but would nevertheless be a routine undertaking for those of ordinary skill in the art having the benefit of this disclosure.

It will be understood that the methods and apparatuses disclosed herein can be used to treat any solids-containing material that has as an undesirable amount of arsenic. Examples of such materials can include byproducts and waste materials from industries such as mining, metal refining, steel manufacturing, glass manufacturing, chemical and petrochemical, as well as contaminated soils, wastewater sludge, and the like. Specific examples can include mine tailings, mats and residues from industrial processes, soils contaminated by effluents and discharges from such processes, spent catalysts, and sludge from wastewater treatment systems. While portions of the disclosure herein refer to the removal of arsenic from mining tailings and residues from hydrometallurgical operations, such references are illustrative and should not be construed as limiting.

The arsenic-bearing material can also contain other inorganic contaminants, such as selenium, cadmium, lead, mercury, chromium, nickel, copper and cobalt, and organic contaminants. The disclosed methods can remove arsenic from such materials even when elevated concentrations of such inorganic contaminants are present. More specifically, arsenic can be effectively removed from solutions prepared from such arsenic-bearing materials that comprise more than about 1000 ppm inorganic sulfates.

The arsenic-bearing materials can also contain particularly high concentrations of arsenic. Solutions prepared from such materials can contain more than about 20 ppb arsenic and frequently contain in excess of 1000 ppb arsenic. The disclosed methods are effective in decreasing such arsenic levels to amounts less than about 20 ppb, in some cases less than about 10 ppb, in others less than about 5 ppb and in still others less than about 2 ppb.

The disclosed methods are also able to effectively fix arsenic from solution over a wide range of pH levels, as well as extreme pH values. In contrast to many conventional arsenic removal techniques, this capability eliminates the need to alter and/or maintain the pH of the solution within a narrow range when removing arsenic. Moreover, it adds flexibility in that the selection of materials and processes for leaching arsenic from an arsenic-bearing material can be made without significant concern for the pH of the resulting arsenic-containing solution. Further still, elimination of the need to adjust and maintain pH while fixing arsenic from an arsenic-containing solution provides significant cost advantages.

In one aspect of the present invention, a method is provided for separating arsenic from an arsenic-bearing material. The method includes the step of contacting an arsenic-bearing material with an arsenic leaching agent to form an arsenic-containing solution and arsenic-depleted solids and separating the arsenic-depleted solids from the arsenic-containing solution. The arsenic-containing solution is contacted with a fixing agent under conditions in which at least a portion of the arsenic is fixed by the fixing agent to yield an arsenic-depleted solution and an arsenic-laden fixing agent and separating the arsenic-laden fixing agent from the arsenic-depleted solution. The fixing agent comprises a rare earth-containing compound.

The arsenic-bearing material is contacted with an arsenic leaching agent to form an arsenic-containing solution and arsenic-depleted solids. Arsenic can be leached from solids such as contaminated soils, industrial byproducts and waste materials by leaching or extraction to release the arsenic from such solids. Within the mining and hydrometallurgical industries, leaching refers to the dissolution of metals or other compounds of interest from an ore or other solid into an appropriate solution. Depending on the nature of the arsenic-bearing materials, pretreatment or processing such as by grinding or milling may be desired to promote dissolution and release of arsenic.

The arsenic leaching agent can include one or more of an inorganic salt, an inorganic acid, an organic acid and an alkaline agent. The selection of the leaching agent will depend on the nature of the arsenic-bearing material and other compounds that are present. Specific examples of inorganic salt leaching agents include potassium salts such as potassium phosphate, potassium chloride, potassium nitrate, potassium sulfate, sodium perchlorate and the like. Examples of inorganic acids that may be used to leach arsenic from solids include sulfuric acid, nitric acid, phosphoric acid, hydrochloric acid, perchloric acid and mixtures thereof. Organic acid leaching agents can include citric acid, acetic acids and the like. Alkaline agents can include sodium hydroxide among others. A more detailed description of arsenic leaching agents and their use may be had by reference to M. Jang et al., “Remediation Of Arsenic-Contaminated Solids And Washing Effluents”, Chemosphere, 60, pp 344-354, (2005); M. G. M. Alam et al., “Chemical Extraction of Arsenic from Contaminated Soil”, J. Environ Sci Health A Tox Hazard Subst Environ Eng, 41 (4), pp 631-643 (2006); and S. R. Al-Abed et al., “Arsenic Release From Iron Rich Mineral Processing Waste; Influence of pH and Redox Potential”, Chemosphere, 66, pp 775-782 (2007).

The arsenic-bearing material is contacted with the leaching agent to form a slurry in a tank, container or other vessel suitable for holding such solutions and materials. Pumps, mixers or other suitable means may be included for promoting agitation and contact between the leaching agent and the arsenic-bearing materials. More specifically, the arsenic-bearing material can be contacted with the arsenic leaching agent in an open tank, a pressure vessel at elevated temperatures, or by flowing or percolating the leaching agent through arsenic-bearing material and collecting the arsenic-containing solution that issues therefrom. Where the leach requires elevated temperatures and pressures to achieve the desired arsenic extraction, an autoclave may be used. Examples of this include pressure oxidation of sulfide-containing ores and concentrates, high-pressure acid leaching of nickel laterites, and wet-air oxidation of organics. Batch and continuous reactors constructed from stainless steel, titanium and other corrosive resistant materials are commercially available for such processes. A more detailed description of leaching in hydrometallurgical operations may be had by reference to www.hazenusa.com.

Following the arsenic leach, the arsenic-containing solution is separated from insoluble materials, referred to herein as arsenic-depleted solids. One or more steps may be required to separate the solution from such liquids solids. A variety of separation options are available, including screening, settling, filtration, and centrifuging, depending on the size and physical characteristics of the solids.

Where the arsenic-depleted solids include a recoverable metal, the method can optionally include the step of separating the recoverable metal from the arsenic-depleted solids. As used herein, recoverable metal can include virtually any metal of interest, but specifically includes metals from Group IA, Group IIA, Group VIII, and the transition metals. One method for recovering a marketable metal product is to use electrochemistry. More specifically, the arsenic-depleted solids can be added to a feedstock of a metal refining process. By way of example, electrowinning or electrorefining are widely used processes for recovering and refining copper, nickel, zinc, lead, cobalt, and manganese dioxide.

Where the arsenic-containing solution includes a recoverable metal as described herein, the method can optionally include the step of separating the recoverable metal from the solution prior to contacting the solution with an arsenic fixing agent. Methods for separating the recoverable metal can include combining the arsenic-containing solution with a process stream in a metal refining process such as a process employing electrochemistry. Another method for separating a recoverable metal from the arsenic-containing solution includes precipitating the recoverable metal from the solution. Precipitation reactions are widely used to recover metal values or to remove impurities from process streams and waste waters. Many hydrometallurgical processes contain one or more precipitation steps. For instance, hydroxide is used to precipitate iron from acid streams, neutralize acid streams for disposal, recover nickel and cobalt hydroxide from sulfate liquors, and remove metals from wastewater. Platinum group metals are also recovered from acidic leach solutions by precipitation. Sulfide is another common compound used in precipitation steps. Hydrogen sulfide is used to recover copper from copper-bearing streams and nickel and cobalt from acid sulfate liquors. Sodium hydrosulfide and calcium sulfide are widely used to remove zinc, copper, lead, silver, and cadmium from waste streams. Therefore, an apparatus of the invention can optionally include a precipitation vessel. In such an embodiment, a separator as described herein can optionally be used to separate precipitated metals from the arsenic-containing solution. A more detailed description of precipitation in hydrometallurgical operations may be had by reference to www.hazenusa.com.

The arsenic-containing solution is contacted with the fixing agent in a tank, container or other vessel suitable for holding such solutions and materials. The solution is at a temperature and pressure, usually ambient conditions, such that the solution remains in the liquid state, although elevated temperature and pressure conditions may be used. The tank may optionally include a mixer or other means for promoting agitation and contact between the arsenic-containing solution and the fixing agent. Non-limiting examples of suitable vessels are described in U.S. Pat. No. 6,383,395, which description is incorporated herein by reference.

The fixing agent can be any rare earth-containing compound that is effective at fixing arsenic in solution through precipitation, adsorption, ion exchange or other mechanism. The fixing agent can be soluble, slightly soluble or insoluble in the aqueous solution. In some embodiments, the fixing agent has a relatively high surface area of at least about 70 m³/g, and in some cases more than about 80 m³/g, and in still other cases more than 90 m³/g. The fixing agent can be substantially free of arsenic prior to contacting the arsenic-containing solution or can be partially-saturated with arsenic. When partially-saturated, the fixing agent can comprise between about 0.1 mg and about 80 mg of arsenic per gram of fixing agent.

The fixing agent can include one or more of the rear earths including lanthanum, cerium, praseodymium, neodymium, promethium, samarium, europium, gadolinium, terbium, dysprosium, holmium erbium, thulium, ytterbium and lutetium. Specific examples of such materials that have been described as being capable of removing arsenic from aqueous solutions include trivalent lanthanum compounds (U.S. Pat. No. 4,046,687), soluble lanthanide metal salts (U.S. Pat. No. 4,566,975), lanthanum oxide (U.S. Pat. No. 5,603,838), lanthanum chloride (U.S. Pat. No. 6,197,201), mixtures of lanthanum oxide and one or more other rare earth oxides (U.S. Pat. No. 6,800,204), cerium oxides (U.S. Pat. No. 6,862,825); mesoporous molecular sieves impregnated with lanthanum (U.S. Patent Application Publication No. 20040050795), and polyacrylonitrile impregnated with lanthanide or other rare earth metals (U.S. Patent Application Publication No. 20050051492). It should be understood that such rare earth-containing fixing agents may be obtained from any source known to those skilled in the art.

In some embodiments, the rare-earth containing compound can comprise one or more of cerium, lanthanum, or praseodymium. Where the fixing agent comprises a compound containing cerium, the fixing agent can be derived from cerium carbonate. More specifically, such a fixing agent can be prepared by thermally decomposing a cerium carbonate or cerium oxalate in a furnace in the presence of air. When the fixing agent comprises cerium dioxide, it is generally preferred to use solid particles of cerium dioxide, which are insoluble in water and relatively attrition resistant. Water-soluble cerium compounds such as ceric ammonium nitrate, ceric ammonium sulfate, ceric sulfate, and eerie nitrate can also be used as the fixing agent, particularly where the concentration of arsenic in solution is high.

Optionally, a fixing agent that does not contain a rare earth compound can also be used. Such optional fixing agents can include any solid, liquid or gel that is effective at fixing arsenic in solution through precipitation, adsorption, ion exchange or some other mechanism. These optional fixing agents can be soluble, slightly soluble or insoluble in aqueous solutions. Optional fixing agents can include particulate solids that contain cations in the +3 oxidation state that react with the arsenate in solution to form insoluble arsenate compounds. Examples of such solids include alumina, gamma-alumina, activated alumina, acidified alumina such as alumina treated with hydrochloric acid, metal oxides containing labile anions such as aluminum oxychloride, crystalline alumino-silicates such as zeolites, amorphous silica-alumina, ion exchange resins, clays such as montmorillonite, ferric salts, porous ceramics. Optional fixing agents can also include calcium salts such as calcium chloride, calcium hydroxide, and calcium carbonate, and iron salts such as ferric salts, ferrous salts, or a combination thereof. Examples of iron-based salts include chlorides, sulfates, nitrates, acetates, carbonates, iodides, ammonium sulfates, ammonium chlorides, hydroxides, oxides, fluorides, bromides, and perchlorates. Where the iron salt is a ferrous salt, a source of hydroxyl ions may also be required to promote the co-precipitation of the iron salt and arsenic. Such a process and materials are described in more detail in U.S. Pat. No. 6,177,015, issued Jan. 23, 2001 to Blakey et al. Other optional fixing agents are known in the art and may be used in combination with the rare earth-containing fixing agents described herein. Further, it should be understood that such optional fixing agents may be obtained from any source known to those skilled in the art.

Particulate solids such as insoluble fixing agents and insoluble arsenic-containing compounds can be separated from the various solutions described herein for further processing. Any liquid-solids separation technique, such as screening, filtration, gravity settling, centrifuging, hydrocycloning or the like can be used to remove such particulate solids. An optional flocculant, coagulant or thickener can also be added to the solution before the particulate solids are removed. Such agents are useful for achieving a desired particle size and improving the settling properties of the arsenic-laden fixing agent. Examples of inorganic coagulants include ferric sulfate, ferric chloride, ferrous sulfate, aluminum sulfate, sodium aluminate, polyaluminum chloride, aluminum trichloride among others. Organic polymeric coagulants and flocculants can also be used, such as polyacrylamides (cationic, nonionic, and anionic), EPI-DMA's (epichlorohydrin-dimethylamines), DADMAC's (polydiallydimethyl-ammonium chlorides), dicyandiamide/formaldehyde polymers, dicyandiamide/amine polymers, natural guar, etc.

The arsenic-laden fixing agent is separated from an arsenic-depleted solution in a separator. In some embodiments, the arsenic laden fixing agent is directed to a filtration unit that is connected to the separator wherein the fixing agent is filtered to produce a filtrate and arsenic-laden solids. The solids are directed out of the filtration unit for appropriate disposal or further handling. The filtration unit has an outlet in fluid communication with the arsenic fixing unit for recycling the filtrate to the contract zone where it is combined with in-coming fresh arsenic-containing solution and contacted with fixing agent.

The rare earth-containing fixing agents of the present invention are particularly advantageous in their ability to remove arsenic from solution over a wide range of pH values and at extreme pH values. The pH of the arsenic-containing solution can be less than about 7 when the arsenic-containing solution is contacted with the first portion of fixing agent. More specifically, the pH of the arsenic-containing solution can be less than about 4, and still more specifically, the pH of the arsenic-containing solution can be less than about 3 when the arsenic-containing solution is contacted with the first portion of fixing agent. In other embodiments, the pH of the arsenic-containing solution can be more than about 7 when the arsenic-containing solution is contacted with the first portion of fixing agent. More specifically, the pH of the arsenic-containing solution can be more than about 9, and still more specifically, the pH of the arsenic-containing solution can be more than about 10 when the arsenic-containing solution is contacted with the first portion of fixing agent. To the extent that it is desirable to adjust or control the pH, an optional acid and/or alkaline addition may be added to the solution as is well known in the art. Acid addition can include the addition of a mineral acid such as hydrochloric or sulfuric acid. Alkaline addition can include the addition of sodium hydroxide, sodium carbonate, calcium hydroxide, ammonium hydroxide and the like.

When the arsenic-containing solution includes a recoverable metal as described herein, the method can optionally include the step of separating the recoverable metal from the arsenic-depleted solution. Where the recoverable metal is in solution in the arsenic-containing solution, the fixing agent is preferably an insoluble compound that selectively adsorbs arsenic from the solution and does not react or reacts only weakly with the recoverable metal to form an insoluble product. The recoverable metal can be separated from the arsenic-depleted solution by combining the arsenic-depleted solution with a process stream in a metal refining process. More specifically, the metal refining process can include electrolyzing the arsenic-depleted solution to separate the recoverable metal from solution. By way of example, the removal of contaminants to form a solution for separating various metals through electrorefining processes is described in detail in U.S. Pat. No. 6,569,224 issued May 27, 2003 to Kerfoot et al.

In another embodiment, the present invention provides an apparatus for removing arsenic from an arsenic-bearing material. The apparatus includes a leaching unit for contacting the arsenic-bearing material with an arsenic leaching agent under conditions such that at least a portion of the arsenic is extracted to form an arsenic-containing solution and arsenic-depleted solids.

A separator is provided for separating the arsenic-containing solution from the arsenic-depleted solids.

The apparatus further includes an arsenic fixing unit operably connected to the leaching unit to receive the arsenic-containing solution. The arsenic fixing unit includes a contact zone having a fixing agent comprising a rare earth-containing compound for contacting the arsenic-containing solution and fixing at least a portion of the arsenic to yield an arsenic-depleted solution and an arsenic-laden fixing agent. The contact zone of the arsenic fixing unit can be disposed in a tank, pipe, column or other suitable vessel.

A separator is provided for separating the arsenic-laden fixing agent from the arsenic-depleted solution.

The fixing agent comprises a rare earth-containing compound. The rare earth-containing compound can include one or more of cerium, lanthanum, or praseodymium. Where the rare earth-containing compound comprises a cerium-containing compound, the cerium-containing compound can be derived from thermal decomposition of a cerium carbonate. The rare earth-containing compound can include cerium dioxide. When a recoverable metal is in solution in the arsenic-containing solution and the fixing agent comprises an insoluble compound that does not react with the recoverable metal to form an insoluble product.

The apparatus can optionally include a filtration unit connected to the arsenic fixing unit for receiving the arsenic-laden fixing agent and producing a filtrate. The filtration unit can optionally be in fluid communication with an inlet of the arsenic fixing unit for recycling the filtrate to the arsenic fixing unit.

The apparatus can optionally further include a second arsenic fixing unit that comprises a contact zone having a fixing agent comprising a rare earth-containing compound for contacting the arsenic-containing solution and fixing at least a portion of the arsenic to yield an arsenic-depleted solution and a separator for separating the arsenic-laden fixing agent from the arsenic-depleted solution. When the apparatus includes a second fixing unit, the apparatus can include a manifold in fluid communication with an inlet of each of the arsenic fixing units for selectively controlling a flow of the arsenic-containing solution to each of the arsenic fixing units, for selectively controlling a flow of a sluce stream to each of the arsenic fixing units and/or for selectively controlling a flow of the fixing agent to each of the arsenic fixing units.

The apparatus can optionally further include a metal recovery unit operably connected at least one of the leaching unit and the arsenic fixing unit for separating a recoverable metal from one or more of the arsenic-depleted solids, the arsenic-containing solution, and the arsenic-depleted solution. The metal recovery unit can include one or more of an electrolyzer and a precipitation unit.

### DETAILED DESCRIPTION OF THE FIGURES

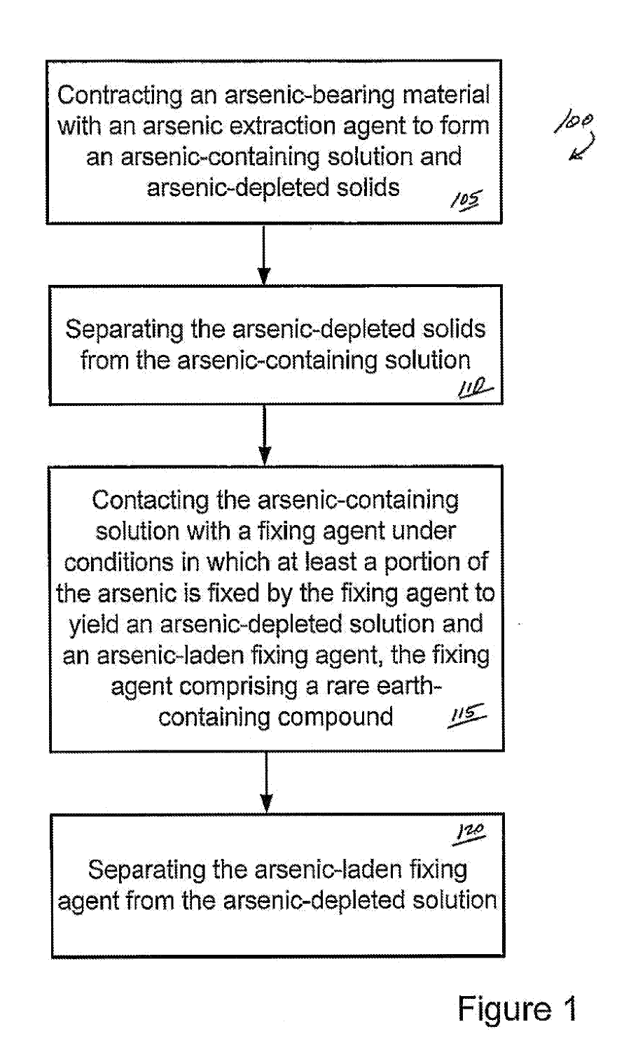

FIG. 1 is a flow chart representation of method 100. Method 100 includes step 105 of contracting an arsenic-bearing material with an arsenic leaching agent to form an arsenic-containing solution and arsenic-depleted solids. In step 110, the arsenic-depleted solids are separated from the arsenic-containing solution. In step 115, the arsenic-containing solution is contacted with fixing agent under conditions in which at least a portion of the arsenic is fixed by the fixing agent to yield an arsenic-depleted solution and an arsenic-laden fixing agent, the fixing agent comprises a rare earth-containing compound. In step 120, the arsenic-laden fixing agent is separated from the arsenic-depleted solution.

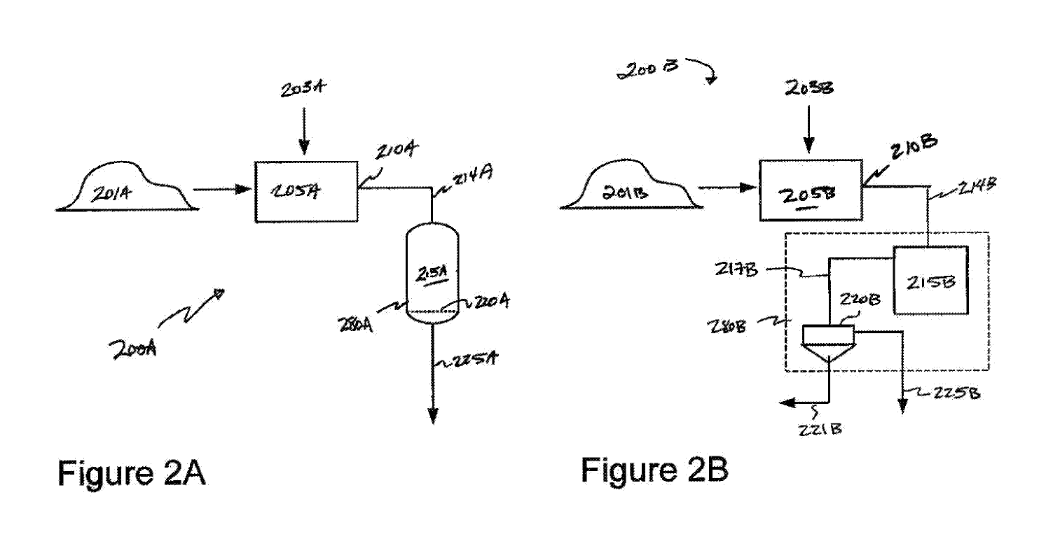

FIG. 2A is a schematic representation of apparatus 200A. Arsenic-bearing material 201A is contacted with leaching agent 203A in arsenic leaching unit 205A. Separator 210A separates an arsenic-containing solution formed in unit 205A from arsenic depleted solids. This solution is directed through line 214A to arsenic fixing unit 280A. The fixing unit 280A includes contact zone 215A where the arsenic is fixed and removed from solution. Separator 220A separates the arsenic-laden fixing agent from the arsenic-depleted solution, which is directed out of the apparatus through line 225A.

FIG. 2B is a schematic representation of apparatus 200B. Arsenic-bearing material 201B is contacted with leaching agent 203B in arsenic leaching unit 205B. The apparatus includes separator 210B for separating an arsenic-containing solution formed in unit 205B from arsenic-depleted solids. This solution is directed through line 214B to arsenic fixing unit 280B. Fixing unit 280B includes tank 215B that is operably connected to separator 220B. An arsenic-depleted solution is directed out of separator 220B and fixing unit 280B through line 225B. Arsenic-laden fixing agent is directed out of separator 220B through line 221B.

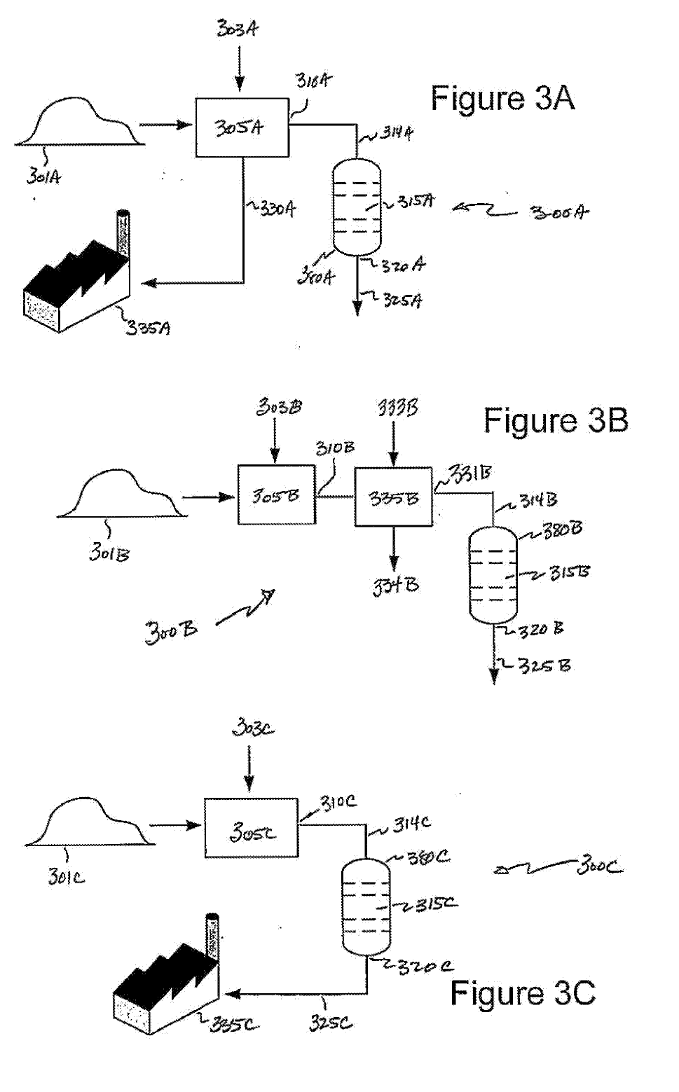

FIG. 3A is a schematic representation of system 300A. Arsenic-bearing material 301A is contacted with leaching agent 303A in arsenic leaching unit 305A. The apparatus includes separator 310A for separating an arsenic-containing solution formed in unit 305A from arsenic-depleted solids. This solution is directed through line 314A to arsenic fixing unit 380A. The fixing unit 380A includes contact zone where the arsenic is fixed and removed from solution. Separator 320A separates the arsenic-laden fixing agent from the arsenic-depleted solution, which is directed out of the apparatus through line 325A. Where the arsenic-depleted solids comprise a recoverable metal, the arsenic-depleted solids can be conveyed on line 330A to metal recovery unit 335A.

FIG. 3B is a schematic representation of apparatus 300B. Arsenic-bearing material 301B is contacted with leaching agent 303B in arsenic leaching unit 305B. The apparatus includes separator 310B for separating an arsenic-containing solution formed in unit 305B from arsenic-depleted solids. This solution is directed to precipitation tank 335B where it is contacted with a precipitation agent 333B to precipitate the recoverable metal from the arsenic-containing solution. Separator 331B separates the precipitated metal from the arsenic-containing solution. The precipitated metal can be directed from the precipitation tank through line 334B for further processing and handling. The arsenic-containing solution is directed through line 314B to arsenic fixing unit 380B. Fixing unit 380B includes contact zone 315B where the arsenic is fixed and removed from solution. Separator 320B separates the arsenic-laden fixing agent from the arsenic-depleted solution, which is directed out of the apparatus through line 325B.

FIG. 3C is a schematic representation of apparatus 300C. Arsenic-bearing material 301C is contacted with leaching agent 303C in arsenic leaching unit 305C. The arsenic leaching unit includes separator 310C for separating an arsenic-containing solution formed in unit 305C from arsenic-depleted solids. This solution is directed through line 314C to arsenic fixing unit 380C. The fixing unit 380C includes contact zone 315C where the arsenic is fixed and removed from solution. Separator 320C separates the arsenic-laden fixing agent from the arsenic-depleted solution. The arsenic-depleted solution comprises a recoverable metal and is directed out of fixing unit 380C through line 325C to a metal recovery unit 335C. Preferably, metal recovery unit 335C includes an electrolyzer (not shown) for separating the recoverable metal from the arsenic-depleted solution.

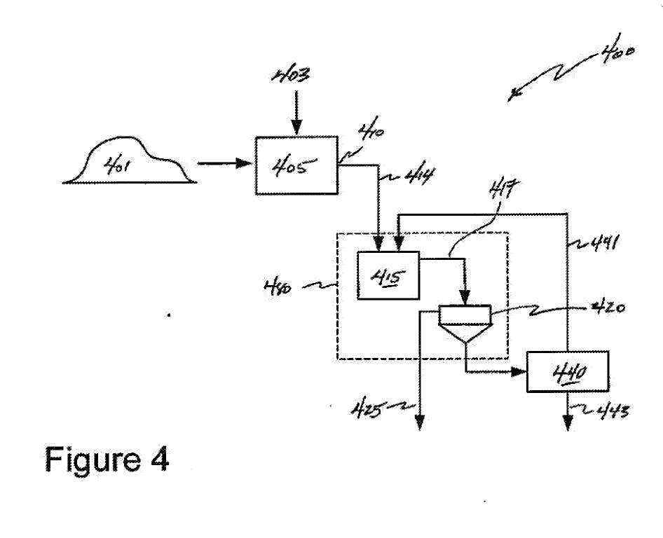

FIG. 4 is a schematic representation of apparatus 400. Apparatus 400 is similar to apparatus 200B that is illustrated in FIG. 2B in that it includes tank 415 and separator 420. Apparatus 400 also includes filtration unit 440 connected downstream of separator 420 for receiving the arsenic-laden fixing agent and producing a filtrate and arsenic-laden solids. The arsenic laden solids are directed out of filtration unit 440 through line 443 to disposal or further handling. The filtrate is directed out of the filtration unit through line 441, which is connected to an inlet of the arsenic fixing unit 480 for combining the filtrate with arsenic-containing solution delivered through line 414.

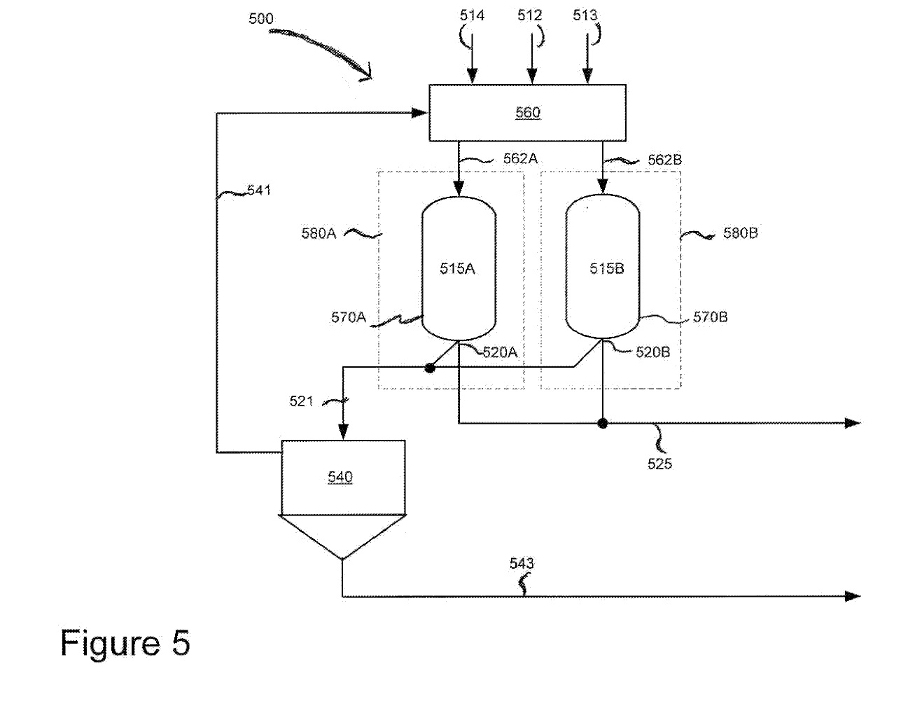

FIG. 5 is a schematic representation of apparatus 500 that includes arsenic fixing units 580A and 580B and filtration unit 540. As illustrated, apparatus 500 includes manifold 560 and a plurality of columns 570A and 570B. The columns have contact zones 515A and 515B and separators 520A and 520B, respectively. Manifold 560 receives arsenic-containing solution through line 514, a sluce solution through line 512 and fresh fixing agent through line 513. Manifold 560 controls the flow of each of these materials to columns 570A and 570B through lines 562A and 562B respectively. Valves (not shown) at the bottom of each of columns 570A and 570B control the flow of arsenic-depleted solution or arsenic-laden fixing agent from the columns.

When the fixing agent in column 570A is saturated and requires replacement, manifold 560 interrupts the flow of arsenic-containing solution to column 570A. The valve (not shown) at the bottom of column 570A is actuated to allow the arsenic-laden fixing agent to flow out through line 521 to filtration unit 540. Manifold 560 directs a sluce stream or solution into column 570A to slurry any residual fixing agent from the column. The slurried fixing agent is likewise directed to filtration unit 540 where a filtrate and arsenic-laden solids are produced. The filtrate is directed back to manifold 560 through line 541 where it is combined with fresh arsenic-containing solution entering the manifold. The arsenic-laden solids are conveyed out of filtration unit 540 on line 543 for disposal or handling. The valve is at the bottom of column 570A is closed and manifold 560 directs a flow of fresh fixing agent into contact zone 515A. While this operation is underway, manifold 560 maintains the flow of arsenic-containing solution into column 570B so as to achieve a continuous process for removing arsenic from the solution. The arsenic-depleted solution separated from the fixing agent in column 570B is then directed out through line 525 for further processing or disposal.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method for removing arsenic from an arsenic-bearing material, the method comprising the steps of:
contacting an arsenic-bearing material with an arsenic leaching agent to form an arsenic-containing solution and arsenic-depleted solids;
separating the arsenic-depleted solids from the arsenic-containing solution;
contacting the arsenic-containing solution with a fixing agent under conditions in which at least a portion of the arsenic is fixed by the fixing agent to yield an arsenic-depleted solution and an arsenic-laden fixing agent, the fixing agent comprising a rare earth-containing compound; and
separating the arsenic-laden fixing agent from the arsenic-depleted solution.

2. The method of claim 1, wherein one or more of the arsenic-containing solution, the arsenic-depleted solids, and the arsenic-depleted solution comprises a recoverable metal.

3. The method of claim 2, further comprising the step of precipitating the recoverable metal from one or more of the arsenic-containing solution and the arsenic-depleted solution.

4. The method of claim 2, further comprises the step of electrolyzing one or more of the arsenic-containing solution and the arsenic-depleted solution to separate the recoverable metal.

5. The method of claim 2, further comprising adding the arsenic-depleted solids to a feedstock in a metal refining process to separate the recoverable metal.

6. The method of claim 1, wherein the arsenic leaching agent comprises one or more of an inorganic salt, an inorganic acid, an organic acid, and an alkaline agent.

7. The method of claim 6, wherein the alkaline agent comprises sodium hydroxide.

8. The method of claim 1, wherein the recoverable metal comprises a metal from Group IA, Group IIA, Group VIII and the transition metals.

9. The method of claim 1, wherein the arsenic-containing solution has a pH of more than about 7 when the arsenic-containing solution is contacted with the fixing agent.

10. The method of claim 9, wherein the arsenic-containing solution has a pH of more than about 9 when the arsenic-containing solution is contacted with the fixing agent.

11. The method of claim 10, wherein the arsenic-containing solution has a pH of more than about 10 when the arsenic-containing solution is contacted with the fixing agent.

12. The method of claim 1, wherein the arsenic-containing solution has a pH of less than about 7 when the arsenic-containing solution is contacted with the fixing agent.

13. The method of claim 12, wherein the arsenic-containing solution has a pH of less than about 4 when the arsenic-containing solution is contacted with the fixing agent.

14. The method of claim 13, wherein the arsenic-containing solution has a pH of less than about 3 when the arsenic-containing solution is contacted with the fixing agent.

15. The method of claim 1, wherein the arsenic-containing solution comprises at least about 1000 ppm sulfate when the arsenic-containing solution is contacted with the fixing agent.

16. The method of claim 1, wherein the recoverable metal is in solution and the fixing agent comprises an insoluble compound that does not react with the recoverable metal to form an insoluble product.

17. The method of claim 1, wherein the rare earth-containing compound comprises one or more of cerium, lanthanum, or praseodymium.

18. The method of claim 17, wherein the rare earth-containing compound comprises a cerium-containing compound derived from thermal decomposition of a cerium carbonate.

19. The method of claim 17, wherein the rare earth-containing compound comprises cerium dioxide.

20. The method of claim 1, wherein the arsenic-depleted solution comprises less than about 20 ppb arsenic.

21. An apparatus for removing arsenic from an arsenic-bearing material, the apparatus comprising:
a leaching unit for contacting the arsenic-bearing material with an arsenic leaching agent under conditions such that at least a portion of the arsenic is extracted to form an arsenic-containing solution and arsenic-depleted solids;
a separator for separating the arsenic-containing solution from the arsenic-depleted solids;
an arsenic fixing unit operably connected to the leaching unit to receive the arsenic-containing solution, the arsenic fixing unit comprising a contact zone having a fixing agent comprising a rare earth-containing compound for contacting the arsenic-containing solution and fixing at least a portion of the arsenic to yield an arsenic-depleted solution and an arsenic-laden fixing agent; and
a separator for separating the arsenic-laden fixing agent from the arsenic-depleted solution.

22. The apparatus of claim 21, further comprising a metal recovery unit operably connected at least one of the leaching unit and the arsenic fixing unit for separating a recoverable metal from one or more of the arsenic-depleted solids, the arsenic-containing solution, and the arsenic-depleted solution.

23. The apparatus of claim 22, wherein the metal recovery unit comprises an electrolyzer.

24. The apparatus of claim 22, wherein the metal recovery unit comprises a precipitation vessel.

25. The apparatus of claim 22, wherein the recoverable metal is in solution in the arsenic-containing solution and the fixing agent comprises an insoluble compound that does not react with the recoverable metal to form an insoluble product.

26. The apparatus of claim 21, wherein the rare earth-containing compound comprises one or more of cerium, lanthanum, or praseodymium.

27. The apparatus of claim 26, wherein the rare earth-containing compound comprises a cerium-containing compound derived from cerium carbonate.

28. The apparatus of claim 26, wherein the rare earth-containing compound comprises cerium dioxide.

29. The apparatus of claim 21, further comprising a filtration unit connected to the arsenic fixing unit for receiving the arsenic-laden fixing agent and producing a filtrate.

30. The apparatus of claim 29, wherein the filtration unit is in fluid communication with an inlet of the arsenic fixing unit for recycling the filtrate to the arsenic fixing unit.

31. The apparatus of claim 21, wherein the contact zone is disposed within a column.

32. The apparatus of claim 21, further comprising a second arsenic fixing unit comprising:
a contact zone having a fixing agent comprising a rare earth-containing compound for contacting the process stream and fixing at least a portion of the arsenic to yield an arsenic-depleted stream comprising the recoverable metal and an arsenic-laden fixing agent; and
a separator for separating the arsenic-laden fixing agent from the arsenic-depleted solution.

33. The apparatus of claim 32, further comprising a manifold in fluid communication with an inlet of each of the arsenic fixing units for selectively controlling a flow of the process stream to each of the arsenic fixing units.

34. The apparatus of claim 32, further comprising a manifold in fluid communication with an inlet of each of the arsenic fixing units for selectively controlling a flow of a sluce stream to each of the arsenic fixing units.

35. The apparatus of claim 32, further comprising a manifold in fluid communication with an inlet of each of the arsenic fixing units for selective controlling a flow of the fixing agent to each of the arsenic fixing units.
